(19) United States
(12) Patent Application Publication
(10) Pub. No.: US 2014/0001907 A1
(43) Pub. Date: Jan. 2, 2014

(54) HIGH-EFFICIENCY POWER GENERATOR

(71) Applicant: Hisayoshi Fukuyanagi, Koto-ku (JP)

(72) Inventor: Hisayoshi Fukuyanagi, Koto-ku (JP)

(21) Appl. No.: 13/984,284

(22) PCT Filed: Feb. 7, 2012
(86) PCT No.: PCT/JP2012/052667

§ 371 Date: Sep. 17, 2013

(30) Foreign Application Priority Data
Feb. 8, 2011 (JP) 2011-025380
Jul. 12, 2011 (JP) 2011-153950

(51) Int. Cl. H02K 3/28; H02K 1/27

(52) U.S. Cl. CPC H02K 3/28; H02K 1/27
USPC 310/156.01; 310/198

(57) ABSTRACT

A high-efficiency power generator has a rotor fixed on an input shaft and having a plurality of magnets in a rotor circumferential direction, and a stator which opposes the rotor in an opposing direction with a predetermined spacing therebetween and having stator coils wound around teeth which protrude in the opposing direction. The stator coils are arranged in an uneven-phase placement.

### BACKGROUND

1. Technical Field

The present invention relates to a high-efficiency power generator having a rotor including a magnet and a stator including a stator coil, and in particular to improvement of a structure of the stator.

2. Related Art

In the related art, a power generator is known which has a rotor fixed on an input shaft and a stator placed with a spacing from the rotor.

When the power generator is a permanent magnet-type power generator which uses a permanent magnet, the rotor has permanent magnets which are placed with an even spacing and in a manner such that N poles and S poles are arranged in an alternating manner in a circumferential direction of the rotor.

The stator has teeth which are formed in a protruding manner and opposing the permanent magnets of the rotor and stator coils wound around the teeth.

In a power generator having this structure, a voltage is induced in the stator coil by an electromagnetic induction action between a rotational magnetic field generated by the rotation of the rotor and the stator coil, causing a current to flow and power to be generated.

When the electric power generated by the power generator is 3-phase AC (alternating current) electric power, normally, the number of the stator coils is 3m (where m is a positive integer), and the stator coils are placed in the circumferential direction with an even spacing, arranged in the order of, for example, U, V, and W phases. In addition, the stator coils are placed to allow retrieval of 3-phase AC electric power with equal magnitude of the electromotive force generated in each phase and with a phase difference of 120°, that is, a symmetric 3-phase AC electric power. The above-described placement of the stator coils with an even spacing in the circumferential direction to reduce unevenness of a reaction with respect to the permanent magnet moving in the circumferential direction, that is, unevenness of the reverse torque, will hereinafter simply be referred to as an even-load placement structure of the stator coils. A placement structure of the stator coils which allows generation of the symmetric 3-phase AC electric power will hereinafter simply be referred to as an even-phase placement structure of the stator coils.

Patent Document 1 discloses a rotary electric machine having a rotor in which a plurality of holes extending in an axial direction are formed in the circumferential direction with an even spacing therebetween and permanent magnets are placed in these holes.

Patent Document 2 discloses a 3-phase AC power generator having a circular cylindrical rotor in which permanent magnets are placed on an inner periphery, and a stator which is provided on the inner periphery of the rotor with a space from the rotor. The stator comprises teeth which are provided to protrude to the outside in a radial direction and stator coils wound around the teeth. In this power generator, the power is generated by an electromagnetic induction action between the permanent magnet and the stator coil generated by the rotation of the rotor.

Patent Document 3 discloses a permanent magnet-type AC power generator comprising an outer rotor in which permanent magnets are placed in a circumferential direction on an inner peripheral surface of a circular cylindrical shape and a stator which is inserted into the rotor and in which stator coils are wound around teeth provided protruding in a circumferential direction.

### RELATED ART REFERENCES

### Patent Document

[Patent Document 1] JP 2000-228838 A
[Patent Document 2] JP 2004-166381 A
[Patent Document 3] JP 2009-148020 A

### SUMMARY

In the 3-phase AC power generator of related art, as described above, the stator coils have the even-load placement structure and the even-phase placement structure. With such a structure, when the rotor is rotated in a high rotation sped range such as 1600 rpm, 2000 rpm, 3500 rpm or 4000 rpm, the symmetric 3-phase AC electric power is generated, and an output specification property of the power generator can be satisfied. However, when the rotor is rotated in the above-described range of high rotational speed, the generated heat is inevitably increased, and there is a possibility that the power generator will be damaged or the lifetime of the power generator will be shortened.

In consideration of this, a configuration can be considered in which the number of the stator coils is simply increased, and the rotor is rotated in a low range of rotational speed such as less than or equal to 1000 rpm, so that the above-described generation of heat is inhibited. However, in the structure of the 3-phase AC power generator of the related art, the magnetic resistance of the stator coil is too strong, and the reverse torques with respect to the permanent magnets are added uniformly to the phases and increased. Thus, the rotor is not rotated or a desired rotational speed of the rotor cannot be achieved, and as a result, a desired output cannot be obtained.

An advantage of one or more embodiments of the present invention is in the provision of a high-efficiency power generator which can achieve a high output with a simple structure and which can achieve size reduction and reduction in the amount of materials used.

According to one aspect of the present invention, there is provided a high-efficiency power generator comprising a rotor which is fixed on an input shaft and which has a plurality of magnets in a circumferential direction, and a stator which opposes the rotor with a predetermined spacing therebetween and which has stator coils wound around teeth which protrude in the opposing direction, wherein the stator coils are arranged in an uneven-phase placement.

According to another aspect of the present invention, the teeth are placed with even spacing in a circumferential direction of the stator, and the stator coils wound around the teeth are connected with respect to an output side such that phase differences between phases are uneven.

According to another aspect of the present invention, the teeth are placed with even spacing in the circumferential direction of the stator, a number of the stator coils wound around the teeth is smaller than a number of the teeth, and the stator coils are connected with respect to the output side such that the phase differences between the phases are uneven.

According to another aspect of the present invention, there is provided a high-efficiency power generator comprising a rotor which is fixed on an input shaft and which has a plurality of magnets in a circumferential direction, and a stator which opposes the rotor with a predetermined spacing therebetween and which has stator coils wound around a plurality of teeth which protrude in the opposing direction, wherein the stator coils are arranged in an uneven-load placement.

According to another aspect of the present invention, the stator coils are placed in an unevenly distributed manner in the circumferential direction of the stator.

According to another aspect of the present invention, a wire diameter of a stator coil wound around a certain tooth differs from wire diameters of the stator coils wound around other teeth.

According to another aspect of the present invention, a number of windings of a stator coil wound around a certain tooth differs from numbers of windings of the stator coils wound around other teeth.

According to another aspect of the present invention, a magnetic force of a certain magnet differs from magnetic forces of other magnets.

According to another aspect of the present invention, there is provided a high-efficiency power generator comprising a rotor which is fixed on an input shaft and which has a plurality of magnets in a circumferential direction, and a stator which opposes the rotor with a predetermined spacing therebetween and which has teeth which protrude in the opposing direction, wherein the teeth are placed with even spacing in a circumferential direction of the stator, stator coils wound around the teeth are placed such that a number of the stator coils is smaller than a number of the teeth, and the stator coils are arranged in an uneven-phase placement.

According to another aspect of the present invention, the stator coil is wound around a plurality of adjacent teeth.

According to another aspect of the present invention, the stator coils are connected with respect to an output side such that phase differences between phases are uneven.

With the high-efficiency power generator according to one or more embodiments of the present invention, a high power can be achieved with a simple structure, the size can be reduced, and the amount of materials used can be reduced.

### BRIEF DESCRIPTION OF DRAWINGS

FIG. 1 is a diagram showing a structure of a stator of a high-efficiency power generator according to an embodiment of the present invention.

FIG. 2 is a diagram showing a structure of a rotor corresponding to the stator of FIG. 1.

FIG. 3 is a diagram showing an output circuit.

FIG. 4 is a diagram showing a structure of a stator of a high-efficiency power generator according to another embodiment of the present invention.

FIG. 5 is a diagram exemplifying output characteristics of the high-efficiency power generator of one or more embodiments of the present invention and a power generator of the related art.

FIG. 6 is a diagram exemplifying output characteristics of the high-efficiency power generator of one or more embodiments of the present invention and a power generator of the related art.

FIG. 7 is a diagram exemplifying output characteristics of the high-efficiency power generator of one or more embodiments of the present invention and a power generator of the related art.

FIG. 8 is a diagram showing a structure of a stator of a high-efficiency power generator according to another embodiment of the present invention.

FIG. 9 is a diagram showing a structure of a rotor corresponding to the stator of FIG. 8.

FIG. 10 is a diagram showing a structure of a stator of a high-efficiency power generator according to another embodiment of the present invention.

FIG. 11 is a diagram exemplifying output characteristics of the high-efficiency power generator of one or more embodiments of the present invention and a power generator of the related art.

FIG. 12 is a diagram exemplifying output characteristics of the high-efficiency power generator of one or more embodiments of the present invention and a power generator of the related art.

FIG. 13 is a diagram exemplifying output characteristics of the high-efficiency power generator of one or more embodiments of the present invention and a power generator of the related art.

FIG. 14 is a diagram showing a placement of stator coils in a high-efficiency power generator according to another embodiment of the present invention.

FIG. 15 is a diagram showing a placement of stator coils in a high-efficiency power generator according to another embodiment of the present invention.

FIG. 16 is a diagram showing an output circuit in another embodiment of the present invention.

FIG. 17 is a diagram showing an output circuit in another embodiment of the present invention.

FIG. 18 is a diagram showing a placement of stator coils in a high-efficiency power generator according to another embodiment of the present invention.

FIG. 19 is a diagram showing a placement of stator coils in a high-efficiency power generator according to another embodiment of the present invention.

FIG. 20 is a diagram showing a structure of a rotor corresponding to the stator of FIG. 1 in another embodiment of the present invention.

FIG. 21 is a diagram showing a structure of a rotor corresponding to the stator of FIG. 1 in another embodiment of the present invention.

### DETAILED DESCRIPTION

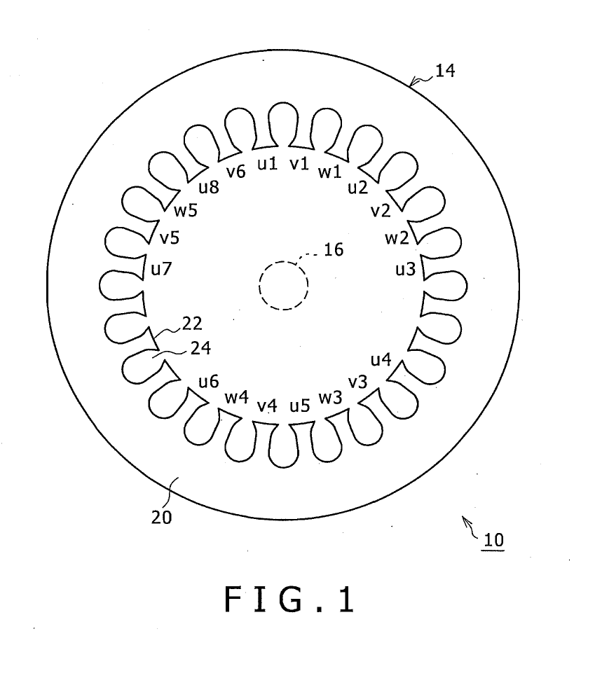

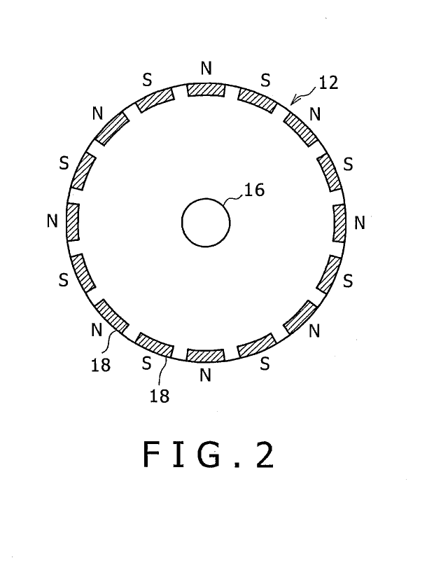

A high-efficiency power generator according to embodiments of the present invention will now be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 is a diagram showing a structure of a stator in the high-efficiency power generator according to an embodiment of the present invention. FIG. 2 is a diagram showing a structure of a rotor corresponding to the stator of FIG. 1.

A high-efficiency power generator 10 (hereinafter simply referred to as “power generator”) according to the present embodiment is a 3-phase AC power generator. The power generator 10 comprises a rotor 12 and a stator 14. The rotor 12 is placed in a rotatable manner at an inner periphery of the stator 14 and with a spacing from the stator 14.

The rotor 12 is a circular cylindrical magnetic structure coaxial with an input shaft 16, and is formed by, for example, layering electromagnetic steel plates in an axial direction. The rotor 12 is fixed on the input shaft 16 in a manner to allow synchronous rotation. As shown in FIG. 2, in the rotor 12, 16 permanent magnets 18 are placed in a circumferential direction. More specifically, 16 permanent magnets 18 are placed with equal spacing such that N poles and S poles are alternately arranged in the circumferential direction of the rotor 12. The number of the permanent magnets 18 is merely exemplary, and may alternatively be any number represented by 2n (where n is a positive integer).

In the present embodiment, the permanent magnets 18 are placed on an outer peripheral surface of the rotor 12 along the axial direction. However, the present embodiment is not limited to such a structure, and the permanent magnets 18 may alternatively be placed by being embedded in holes formed in the rotor 12 and extending in the axial direction. In addition, in the present embodiment, an example configuration is described in which the rotor 12 is formed by layering the electromagnetic steel plates, but the present embodiment is not limited to such a configuration, and the rotor 12 may alternatively be formed by molding a powder magnetic core.

The stator 14 is placed around the rotor 12 with a slight gap therebetween. The stator 14 is a circular cylindrical magnetic structure coaxial with the input shaft 16, and is formed by, for example, layering electromagnetic steel plates in the axial direction. More specifically, the stator 14 is formed by stamping thin-plate electromagnetic steel plates with a stamping die, layering a predetermined number of stamped electromagnetic steel plates in the axial direction, and combining the plurality of layered electromagnetic steel plates through a process such as pressurized caulking.

In the present embodiment, an example configuration is described in which the stator 14 is formed by layering the electromagnetic steel plates, but the present embodiment is not limited to such a configuration, and the stator 14 may alternatively be formed from a powder magnetic core.

The stator 14 comprises a ring-shaped yoke 20 and teeth 22 which protrude from the inner periphery of the yoke 20 toward the inner side in the radial direction and which are placed in the circumferential direction with a predetermined space therebetween. As shown in FIG. 1, in the present embodiment, 24 teeth are placed in the circumferential direction. The number of the teeth 22 is merely exemplary.

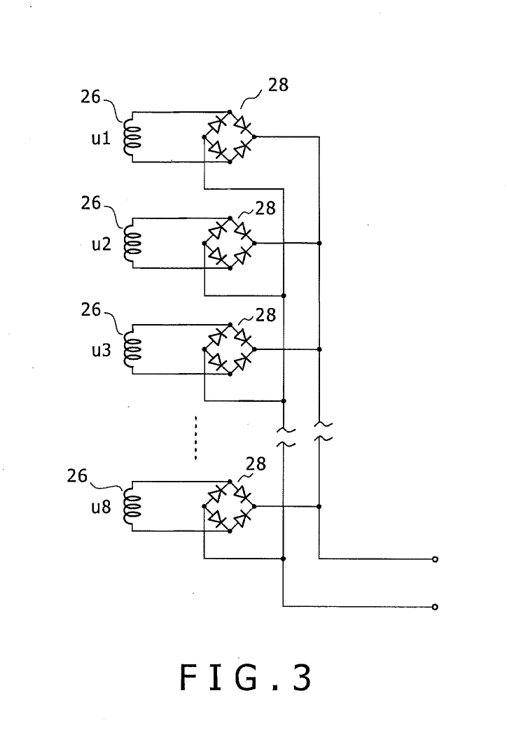

In the area between adjacent teeth 22, a slot 24 which is a channel-like space is formed. A conducting wire passes through the slot 24 and wound around the tooth 22 to form a stator coil 26 (shown in FIG. 3).

In the power generator 10 having such a structure, a voltage is induced in the stator coil 26 by an electromagnetic induction action caused between a rotational magnetic field generated by a rotation of the rotor 12 and the stator coil 26, causing a current to flow and power to be generated.

A characteristic of the power generator 10 of the present embodiment is that the stator coils 26 are arranged in an uneven-phase placement. The uneven-phase placement refers to a placement of the stator coils 26 in which electric power which is not symmetric 3-phase AC electric power is generated, and the placement differs from the even-phase placement described above with reference to the related art. In the power generator 10 which employs such an uneven-phase placement of the stator coils 26, an increase in the reaction with respect to the rotating rotor 12, that is, an increase in the reverse torque with respect to the permanent magnet 18, is inhibited compared to the structure of the even-phase placement, and therefore the rotational speed of the rotor 12 is increased and the output can be increased. A specific structure of the uneven-phase placement of the stator coils 26 will now be described.

In FIG. 1, addresses of U1-U8 are assigned in order in the clockwise direction for the teeth 22 around which U-phase stator coils 26 are wound. Similarly, addresses of V1-V6 are assigned to the teeth 22 around which V-phase stator coils 26 are wound, and addresses of W1-W5 are assigned to the teeth 22 around which W-phase stator coils 26 are wound. In the stator 14 shown in FIG. 1, there are 5 teeth 22 in which the addresses of the stator coils 26 are not assigned.

In the U-phase stator coils 26, coils U1-U6 and U7-U8 are wound around the teeth 22 with teeth 22 of 2 phases therebetween, coils U6-U7 are wound around the teeth 22 with teeth 22 of 3 phases therebetween, and coils U8-U1 are wound around the teeth 22 with the teeth 22 of 1 phase therebetween. In the V-phase stator coils 26, coils V1-V2, V3-V4, and V5-V6 are wound around the teeth 22 with teeth 22 of 2 phases therebetween, coils V2-V3 are wound around the teeth 22 with teeth 22 of 5 phases therebetween, coils V4-V5 are wound around the teeth 22 with the teeth 22 of 6 phases therebetween, and the coils V6-V1 are wound around the teeth 22 with the teeth 22 of 1 phase therebetween. In the W-phase stator coils 26, coils W1-W2 and W3-W4 are wound around the teeth 22 with the teeth 22 of 2 phases therebetween, coils W2-W3 are wound around the teeth 22 with the teeth 22 of 5 phases therebetween, coils W4-W5 are wound around the teeth 22 with the teeth 22 of 6 phases therebetween, and coils W5-W1 are wound around the teeth 22 with the teeth 22 of 4 phases therebetween.

In the power generator of the related art, the stator coils of each phase are wound around the teeth with the teeth of 2 phases therebetween, and are placed such that the phase differences between the phases are even and 120°. On the other hand, in the power generator 10 of the present embodiment, the stator coils 26 are placed with the phase differences between the phases not even and 120°, but uneven in at least a part of the stator coils 26. With such a configuration, uneven-phase placement of the stator coils 26 can be realized.

In addition, as shown in FIG. 1, the number of the stator coils 26 to be wound around the teeth 22, which is 19, is smaller than the number of teeth 22, which is 24. The stator coils 26 are placed with uneven phase differences between the phases. With such a configuration also, the uneven-phase placement of the stator coils 26 can be realized. Such a configuration where the stator coils 26 are not placed with an even spacing in the circumferential direction corresponds to an uneven-load placement to be described later. As described, in one or more embodiments of the present invention, the uneven-phase placement and the uneven-load placement of the stator coils 26 can be combined.

In the present embodiment, an example configuration has been described in which the number of the stator coils 26 is 19, but the present invention is not limited to the number of the stator coils 26 being 19. The number of the stator coils 26 may be less than 19, or may be 24, in which case the stator coils 26 are wound around all teeth 22. In any of these configurations, the stator coils 26 provided on the teeth 22 and the output side are connected such that the phase differences between the phases are uneven or a part of the stator coils 26 and the output side are not connected, so as to realize the uneven-phase placement of the stator coils 26.

Next, an output circuit of the power generator 10 will be described with reference to FIG. 3. In the output circuit of the power generator 10 of one or more embodiments of the present invention, as shown in FIG. 3, the output terminals of the stator coils 26 of each phase, for example, the coils U1, U2, U3, . . . U8 and rectifying circuits 28 corresponding to the stator coils are respectively connected, and the outputs of the stator coils 26 of the same phase are connected in parallel to each other at the output side of the rectifying circuits 28. With such an output circuit, the output current of each phase can be increased compared to the structure of the output circuit of the related art in which the rectifying circuits are respectively connected to 3 terminals of a Y connection or a Δ connection. On the other hand, in the output circuit, the output voltage of each phase is reduced compared to the output circuit of the related art. However, as described above, with the uneven-phase placement of the stator coils 26, because the rotational speed of the rotor 12 is increased compared to the related art, a voltage increase can be achieved for each stator coil 26. Therefore, with the structure of the power generator 10 and the output circuit according to the present embodiment, a high output can be reliably obtained compared to the related art, and in particular, the structure is useful when the output power is directly charged to a charger such as a secondary battery. In addition, according to one or more embodiments of the present invention, when the electric power generated by the power generator 10 is to be charged to the charger, a structure is employed in which the output terminals of the stator coils 26 are respectively connected to the corresponding rectifiers 28, and the outputs of the stator coils 26 are connected in parallel at the output side of the connected structure, that is, a single-phase output-type structure is employed.

In the present embodiment, an example configuration is described in which the power generator 10 is an inner rotation type power generator in which the rotor 12 is placed at an inner side of the stator 14, but the present invention is not limited to such a configuration, and the power generator 10 may alternatively have an outer rotation type power generator in which the rotor is placed on an outer side of the stator.

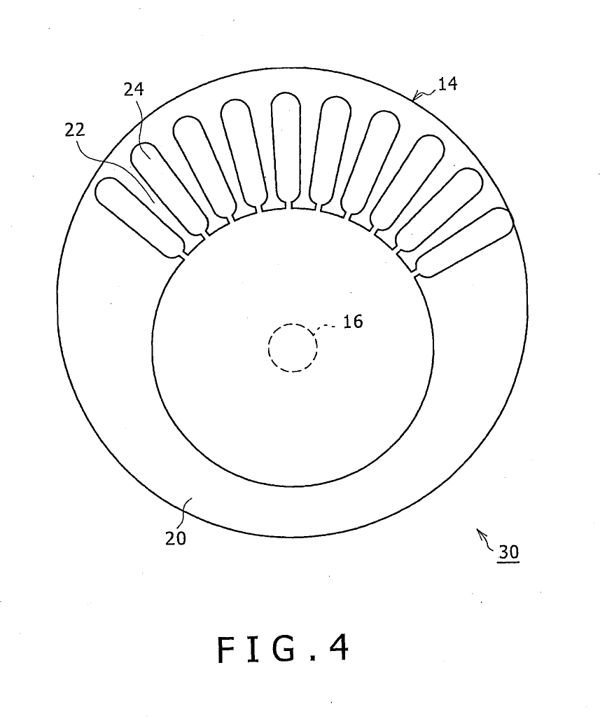

Next, a power generator 30 according to another embodiment of the present invention will be described with reference to FIG. 4. FIG. 4 is a diagram showing a structure of a stator of a high-efficiency power generator according to another embodiment of the present invention. The same constituting elements as in the above-described embodiment are assigned the same reference numerals, and will not be described in detail. A structure of a rotor corresponding to the stator in the present embodiment is similar to that shown in FIG. 2.

A characteristic of the power generator 30 in the present embodiment is that the stator coils 26 are arranged in an uneven-load placement. The uneven-load placement refers to a placement of the stator coils 26 in which an unevenness occurs in the reaction with respect to the permanent magnets moving in the circumferential direction, that is, in the reverse torque, and differs from the even-load placement described above with reference to the related art. In the power generator 30 which employs such an uneven-load placement of the stator coils 26, the increase of the reaction with respect to the rotating rotor 12, that is, the increase of the reverse torque with respect to each permanent magnet 18 is inhibited compared to the even-load placement, and therefore, the rotational speed of the rotor 12 can be increased and the output can be increased. A specific structure of the uneven-load placement of the stator coils 26 will now be described.

The stator coils 26 of the present embodiment are placed to be unevenly distributed in the circumferential direction of the stator 14. Uneven distribution in the circumferential direction means that the stator coils 26 are concentrated in a predetermined region in the circumferential direction. As shown in FIG. 4, 9 teeth 22 are placed concentrated in a sector region surrounded by a predetermined angle (for example, 120°) from the center of the input shaft 16. Although not shown in FIG. 4, the stator coils 26 are respectively wound around the teeth 22. In this manner, the stator coils 26 are placed concentrated in a predetermined region in the circumferential direction. The numbers of the teeth and the stator coil 26, which are 9, are merely exemplary, and the present invention is not limited to these numbers. In addition, in the present embodiment, an example configuration is described in which the teeth 22 are unevenly distributed, but the present invention is not limited to such a configuration, and alternatively, a configuration may be employed in which the teeth 22 are formed with even spaces in the circumferential direction and the stator coils 26 are wound around a part of the teeth 22 so that the stator coils 26 are unevenly distributed in the circumferential direction.

The phases of the stator coils 26 in the present embodiment can be arbitrarily set. That is, output power can be retrieved by an independent (single-phase) output system in which an output circuit is connected to each stator coil 26. Alternatively, the stator coils 26 may be placed with even spaces, with the phases arranged in the order of U, V, and W phases in the circumferential direction, that is, the stator coils 26 may be placed in the even-phase placement, and the output power may be retrieved by the 3-phase AC output system in which the output circuit is connected to each phase. Alternatively, the stator coils 26 may be placed with the U, V, and W phases arranged in the circumferential direction in a disordered manner, and the output power may be retrieved by the 3-phase AC output system in which the output circuit is connected to each phase. Because an output terminal is provided for each stator coil 26 and the phase of the stator coil 26 can be arbitrarily set by merely changing the connecting method of the output terminal, it is possible to improve the degree of freedom of design of the stator 14 and to facilitate adjustment of the output power.

As described, in the present embodiment, the teeth 22 and the stator coils 26 corresponding to the teeth 22 are placed in an unevenly distributed manner in the circumferential direction. In the power generator of the related art, the stator coils placed with even spaces in the circumferential direction are placed such that a predetermined reverse torque, commonly referred to as a load, is applied to each permanent magnet moving in the circumferential direction, with a even spacing. On the other hand, in the power generator 30 of one or more embodiments of the present invention, because the stator coils 26 are placed in an unevenly distributed manner in the circumferential direction, the load applied to each permanent magnet when the permanent magnet moves in the circumferential direction is not even, and is uneven. With the uneven distribution of the stator coils 26 in the circumferential direction in this manner, the uneven-load placement of the stator coils 26 can be realized.

In the present embodiment, an example configuration is described in which the uneven-load placement of the stator coils 26 is formed by uneven distribution of the stator coils 26, but the present invention is not limited to such a configuration. So long as the load in the circumferential direction becomes uneven, a configuration may be employed in which a wire diameter of the stator coil 26 wound around a certain tooth 22 differs from the wire diameters of the stator coils 26 wound around other teeth 22. Alternatively, a configuration may be employed in which a number of windings of the stator coil 26 wound around a certain tooth 22 differs from the number of windings of the stator coils 26 wound around the other teeth 22. Alternatively, the uneven-load placement of the stator coils 26 may be realized by a combination of these configurations. Alternatively, a configuration may be employed in which the magnetic force of a certain permanent magnet 18 differs from the magnetic forces of the other permanent magnets 18 so that the load applied to these permanent magnets when the permanent magnets move in the circumferential direction is not even, that is, uneven.

Referring again to FIG. 4, a characteristic of the stator 14 of the present embodiment is that the stator 14 has a circular cylindrical shape decentered with the input shaft 16. More specifically, the center of the stator 14 in the outer periphery and the center in the inner peripher, which is coaxial with the input shaft 16, differ from each other. Such a structure of the stator 14 is particularly useful when the uneven distribution of the stator coils 26 in the circumferential direction is achieved, and the size of the stator 14 can be reduced with such a structure. With this structure, a region is created in which a length of the stator 14 in the radial direction is enlarged, and in this region, a slot 24 having a longer length in the radial directio, and the teeth 22, can be formed while maintaining the width of the yoke 20. With the slot 24 and the teeth 22 thus formed, compared to the stator of the related art with the same outer diameter, at least one of the number of windings or the wire diameter of the conducting wire wound per tooth 22 can be increased and the capacity of the stator coil 26 can be increased. With the increase in the wire diameter, the number of windings can be reduced, for example, to one, to obtain a larger output current. In addition, when the stator 14 of the present embodiment and the stator of the related art are of the same outer diameter, all of the conducting wires of the lengths used in the stator coils, of the related art, placed with even spaces in the circumferential direction can be wound around the teeth 22 which is formed in a larger size as described above.

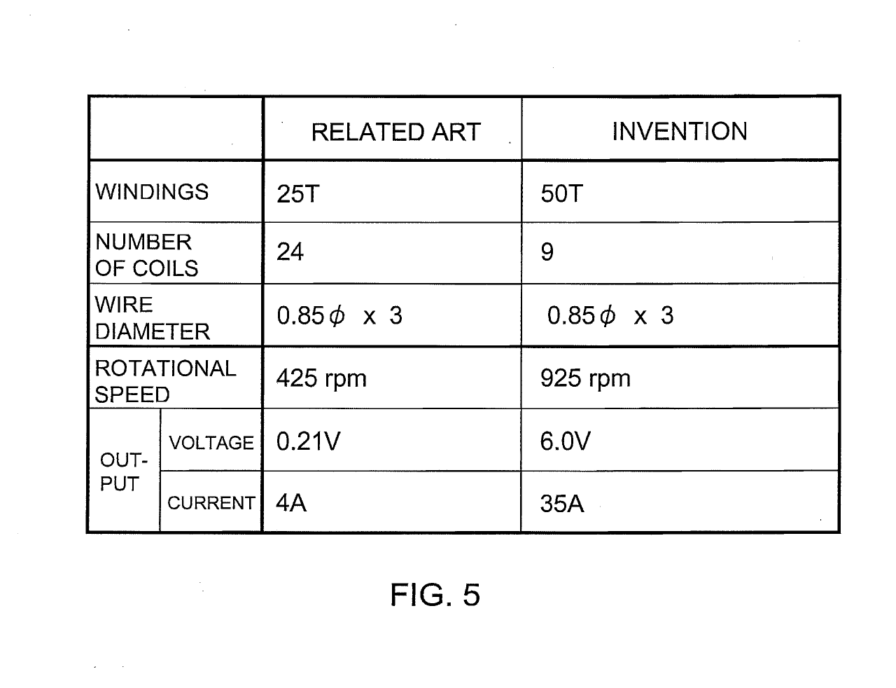

Next, an output characteristic of the power generator 30 of the present embodiment will be described with reference to FIGS. 5-7. FIGS. 5-7 show output characteristics of the high-efficiency power generator of one or more embodiments of the present invention and the power generator of the related art. In FIGS. 5-7, for the output circuit of the related art, a load is connected to a A connection through a rectifier, and for the output circuit of one or more embodiments of the present invention, a structure identical to that of FIG. 3 is employed and a load is connected to the power generator 30 through the rectifier 28. The load is common to all configurations and 3 lamps of 100 w/12V are employed. The numbers of permanent magnets used in the related art and one or more embodiments of the present invention are both 16, and the magnetization forces are the same.

As shown in FIG. 5, the conditions of the related art were set such that the number of turns of the windings was 25 T, the number of stator coils was 24, and the wire diameter was 0.859×3 lines. The measured values under these conditions were as follows: the rotational speed of the rotor was 425 rpm, the output voltage was 0.21 V, and the output current was 4 A. On the other hand, in one or more embodiments of the present invention, the conditions were changed from those of the related art such that the number of turns of the windings was 50 T and the number of stator coils 26 was 9. The measured values were as follows: the rotational speed of the rotor 12 was 925 rpm, the output voltage was 6.0 V, and the output current was 35 A.

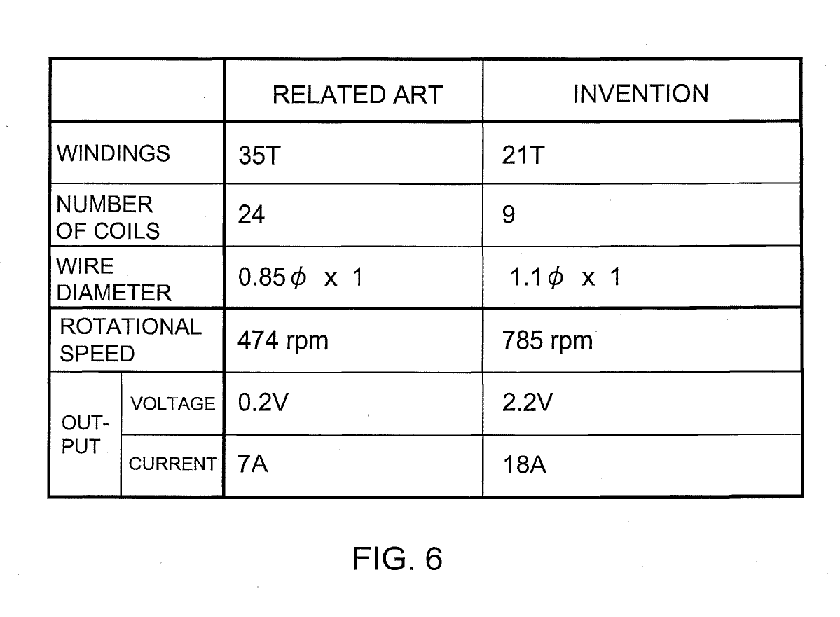

In FIG. 6, the conditions for the related art were such that the number of turns of the windings was 35 T, the number of stator coils was 24, and the wire diameter was 0.85φ×1 line. The measured values under these conditions were as follows: the rotational speed of the rotor was 474 rpm, the output voltage was 0.2 V, and the output current was 7 A. On the other hand, in one or more embodiments of the present invention, the conditions were changed from those of the related art such that the number of turns of the windings was 21 T, the number of stator coils 26 was 9, and the wire diameter was 1.1φ×1 line. The measured values were as follows: the rotational speed of the rotor 12 was 785 rpm, the output voltage was 2.2 V, and the output current was 18 A. Because the winding is 1 line, a large current flows through the winding, and because the wire diameter is larger, the output current can be further increased.

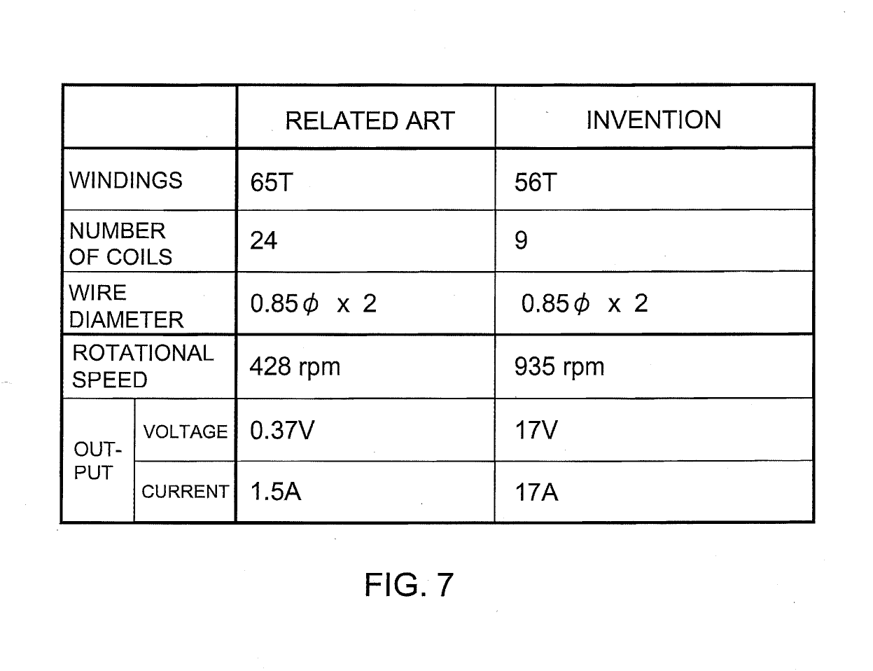

In FIG. 7, the conditions for the related art were such that the number of turns of the windings was 65 T, the number of stator coils was 24, and the wire diameter was 0.85φ×2 lines. The measured values under these conditions were as follows: the rotational speed of the rotor was 428 rpm, the output voltage was 0.37 V, and the output current was 1.5 A. On the other hand, in one or more embodiments of the present invention, the conditions were changed from those of the related art such that the number of turns of the windings was 56 T, and the number of stator coils 26 was 9. The measured values were as follows: the rotational speed of the rotor 12 was 935 rpm, the output voltage was 17 V, and the output current was 17 A.

As shown by these output characteristics, the power generator 30 had an increased rotational speed of the rotor 12 and a higher output than the power generator of the related art. In other words, with the configuration of the uneven-load placement of the stator coils 26, the rotational speed of the rotor 12 is increased and a higher output is enabled. In addition, in the power generator 30, because the number of stator coils 26 is reduced compared to the related art, reduction in the amount of materials used can be achieved.

In the present embodiment, an example configuration of an inner rotation type power generator has been described in which the rotor 12 is placed at an inner side of the stator 14, but the present invention is not limited to such a configuration, and the power generator 30 may be an outer rotation type power generator 32 in which the rotor is placed at an outer side of the stator.

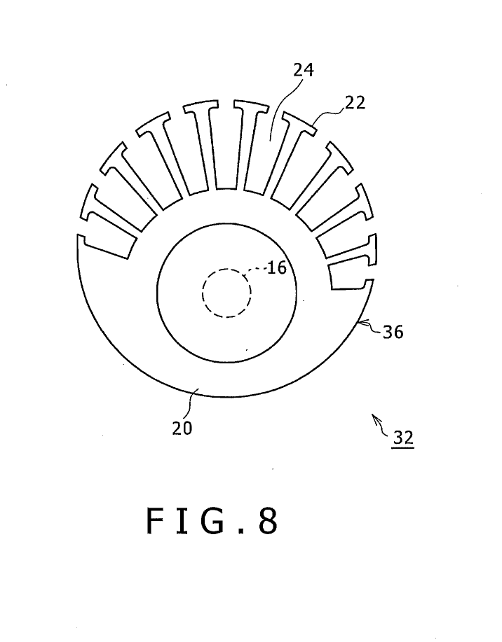

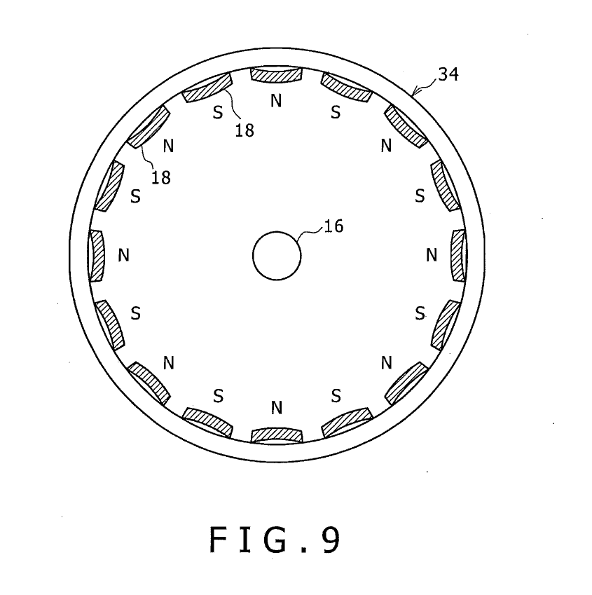

A structure of the power generator 32 will now be described with reference to FIGS. 8 and 9. FIG. 8 is a diagram showing a structure of a stator of a high-efficiency power generator according to another embodiment of the present invention, and FIG. 9 is a diagram showing a structure of a rotor corresponding to the stator of FIG. 8. Constituting elements identical to the two above-described embodiments are assigned the same reference numerals, and will not be described in detail.

The power generator 32 comprises a hollow circular cylindrical shape rotor 34 and a stator 36 provided on an inner periphery of the rotor 34 with a space therebetween. The rotor 34 and the input shaft 16 are fixed to allow synchronous rotation at an end in the axial direction. On the inner periphery of the rotor 34, permanent magnets 18 are placed in the circumferential direction with even spacing. More specifically, 16 permanent magnets 18 are placed with even spacing such that the N poles and the S poles are arranged in an alternating manner in the circumferential direction of the rotor 34. The number of permanent magnets 18 is merely exemplary, and the number of the permanent magnets 18 may be any number represented by 2n (where n is a positive integer).

The stator 36 in the present embodiment has a hollow circular cylindrical shape, through which the input shaft 16 passes, and which is decentered from the input shaft 16. In other words, the center at the outer periphery of the stator 36 and the center at the inner periphery, which is coaxial with the input shaft 16, differ from each other. Similar to the stator 14 of the above-described embodiment, this structure is particularly useful when the uneven distribution of the stator coils 26 (not shown) in the circumferential direction is to be achieved, and the size of the stator 36 can be reduced.

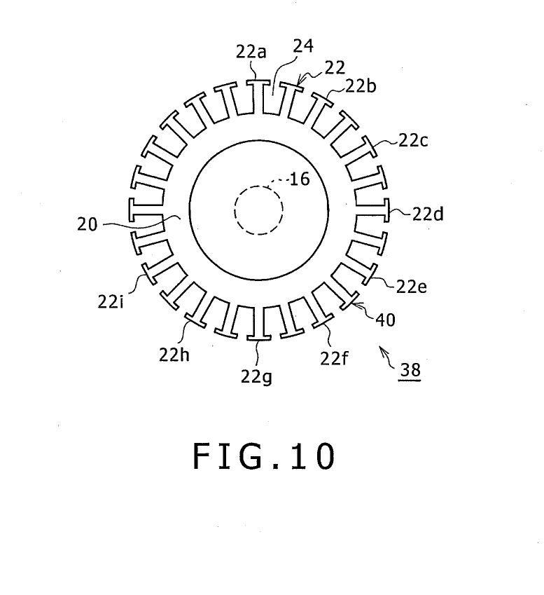

Next, a power generator 38 according to another embodiment of the present invention will be described with reference to FIG. 10. FIG. 10 is a diagram showing a structure of a stator of a high-efficiency power generator according to another embodiment of the present invention. Constituting elements identical to those in the above-described embodiments are assigned the same reference numerals and will not be described in detail. The structure of the rotor corresponding to the stator of the present embodiment is identical to that shown in FIG. 9.

The power generator 32 is an outer rotation type power generator in which the rotor 34 is placed at an outer side of the stator 40. The stator 40 has a hollow circular cylindrical shape, through which the input shaft 16 passes, and which is coaxial with the input shaft 16. In other words, the center at the outer periphery of the stator 40 and the center at the inner periphery, which is coaxial with the input shaft 16, are the same.

The stator 40 comprises a ring-shaped yoke 20 and teeth 22 which protrude from an outer periphery of the yoke 20 toward an outside in the radial direction and which are placed in the circumferential direction with a predetermined spacing. As shown in FIG. 10, in the present embodiment, 24 teeth are placed in the circumferential direction. The number of teeth 22 is merely exemplary. In the area between adjacent teeth 22, a slot 24 which is a channel-like space is formed.

In FIG. 10, addresses of 22a-22i are assigned in the order in the clockwise direction for the teeth 22 around which the stator coils 26 (not shown) are wound. More specifically, with a tooth 22a as a starting point, the addresses are assigned in the order in the clockwise direction to the tooth 22i, with one tooth 22 interposed. Therefore, 9 stator coils are placed in an uneven distribution in a sector region surrounded by a predetermined angle (for example, 240°) from the center of the input shaft 16. This placement is merely exemplary, and the present invention is not limited to such a configuration. So long as the uneven distribution of the stator coils 26 in the circumferential direction is formed, the number of the stator coils 26 may be smaller or larger than 9. In addition, the places of the teeth 22 around which the stator coils 26 are wound are not limited, and the stator coils 26 may be consecutively wound around adjacent teeth 22 or 2 teeth 22 may be interposed.

Similar to the above-described embodiment, the phases of the stator coils 26 can be arbitrarily set in the present embodiment. In other words, the output electric power can be retrieved by an independent (single-phase) output method in which an output circuit is connected to each stator coil 26. Alternatively, the stator coils 26 may be placed with even spacing and arranged in the order of the U, V, and W phases in the circumferential direction, that is, in an even-phase placement, and the output electric power may be retrieved by the 3-phase AC output method in which the output circuit is connected to each phase. Alternatively, the stator coils 26 may be placed such that the U, V, and W phases are arranged in a disordered manner in the circumferential direction, and the output electric power may be retrieved by the 3-phase AC output method in which the output circuit is connected to each phase. Because an output terminal is provided for each stator coil 26 and the phases of the stator coils 26 can be arbitrarily set by merely changing the connecting method of the output terminals, the degree of freedom of design of the stator 40 can be improved and adjustment of the output electric power can be facilitated.

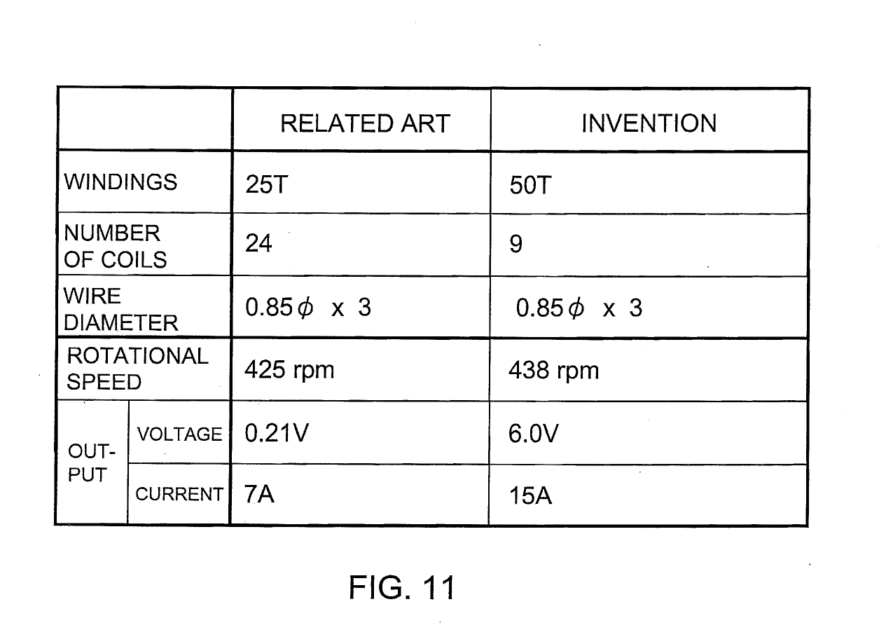

Next, an output characteristic of the power generator 38 according to the present embodiment will be described with reference to FIGS. 11-13. FIGS. 11-13 show examples of the output characteristics of the high-efficiency power generator of one or more embodiments of the present invention and the power generator of the related art. In FIGS. 11-13, for the output circuit of the related art, a load is connected to a Δ connection through a rectifier, and for the output circuit of one or more embodiments of the present invention, a structure identical to that of FIG. 3 is employed, and a load is connected to the power generator 38 through the rectifier 28. The load is common to all configurations and 3 lamps of 100 w/12V are employed. The numbers of the permanent magnets used in the related art and in one or more embodiments of the present invention are both 16, and the magnetization forces are the same.

As shown in FIG. 11, the conditions of the related art were such that the number of turns of the windings was 25 T, the number of stator coils was 24, and the wire diameter was 0.85φ×3 lines. The measured values under these conditions were as follows: the rotational speed of the rotor was 425 rpm, the output voltage was 0.21 V, and the output current was 7 A. On the other hand, in one or more embodiments of the present invention, the conditions were changed from the related art such that the number of turns of the windings was 50 T and the number of the stator coils 26 was 9. The measured values were as follows: the rotational speed of the rotor 34 was 438 rpm, the output voltage was 6.0 V, and the output current was 15 A.

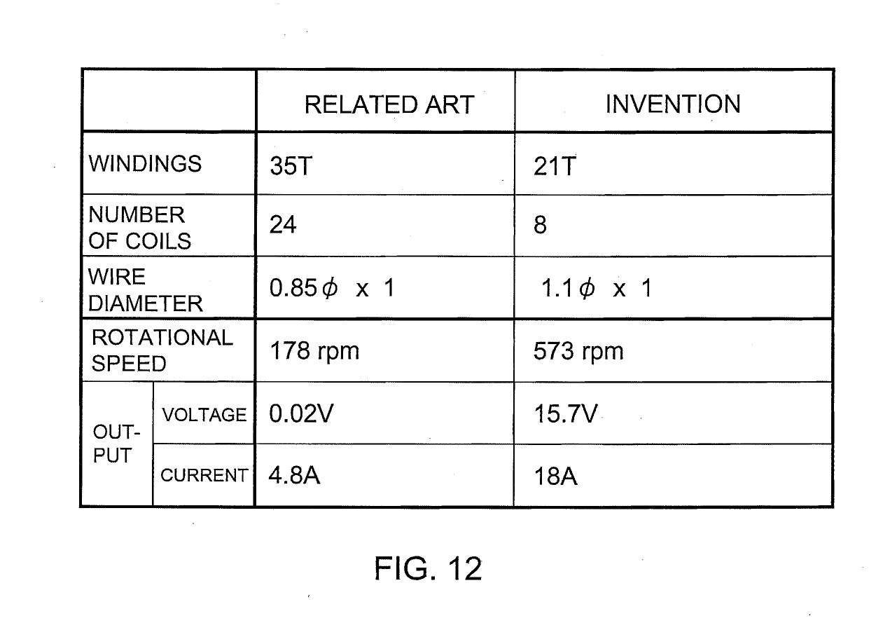

In FIG. 12, the conditions of the related art were set such that the number of turns of the windings was 35 T, the number of stator coils was 24, and the wire diameter was 0.85φ×1 line. The measured values under these conditions were as follows: the rotational speed of the rotor was 178 rpm, the output voltage was 0.02 V, and the output current was 4.8 A. On the other hand, in one or more embodiments of the present invention, the conditions were changed from the related art such that the number of turns of the windings was 21 T, the number of stator coils 26 was 8, and the wire diameter was 1.1φ×1 line. The measured values were as follows: the rotational speed of the rotor 34 was 573 rpm, the output voltage was 15.7 V, and the output current was 18 A.

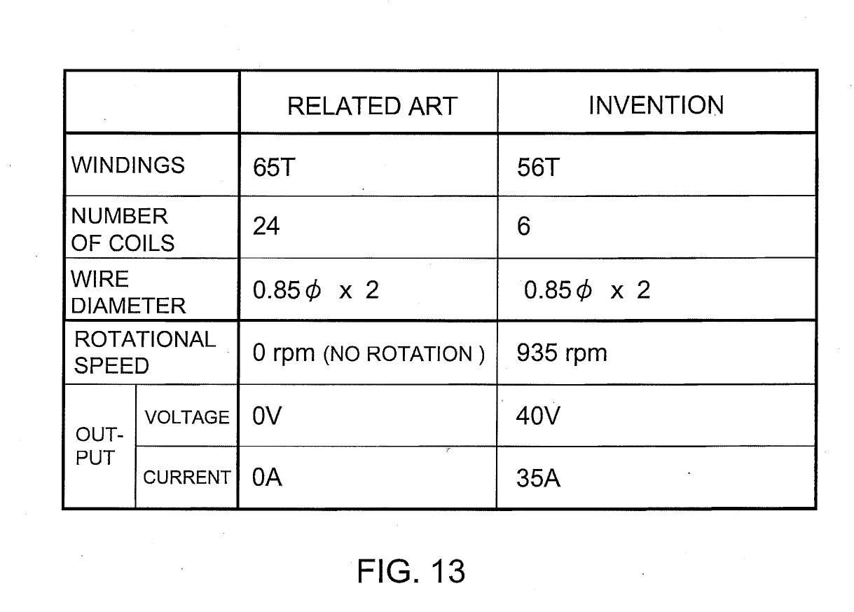

In FIG. 13, the conditions of the related art were set such that the number of turns of the windings was 65 T, the number of stator coils was 24, and the wire diameter was 0.85φ×2 lines. The measured values under these conditions were as follows; the rotational speed of the rotor was 0 rpm, that is, the rotor did not rotate, the output voltage was 0 V, and the output current was 0 A. On the other hand, in one or more embodiments of the present invention, the conditions were changed from the related art such that the number of turns of the windings was 56 T, and the number of the stator coils 26 was 6. Even though the input was the same, the measured values were as follows: the rotational speed of the rotor 34 was 935 rpm, the output voltage was 40 V, and the output current was 35 A.

As shown by these output characteristics, the power generator 38 has an increased rotational speed of the rotor 34 and higher output compared to the power generator of the related art. In other words, by employing the structure of the uneven-load placement of the stator coils 26, it is possible to increase the rotational speed of the rotor 34 and achieve a higher output.

Next, a placement of stator coils of a high-efficiency power generator according to another embodiment of the present invention will be described with reference to 4 diagrams. In the stators in these diagrams, teeth 22 are placed with even spacing in the circumferential direction. However, in these diagrams, in order to facilitate viewing the teeth 22, the teeth 22 which are normally placed in the circumferential direction are shown re-arranged in a straight line shape.

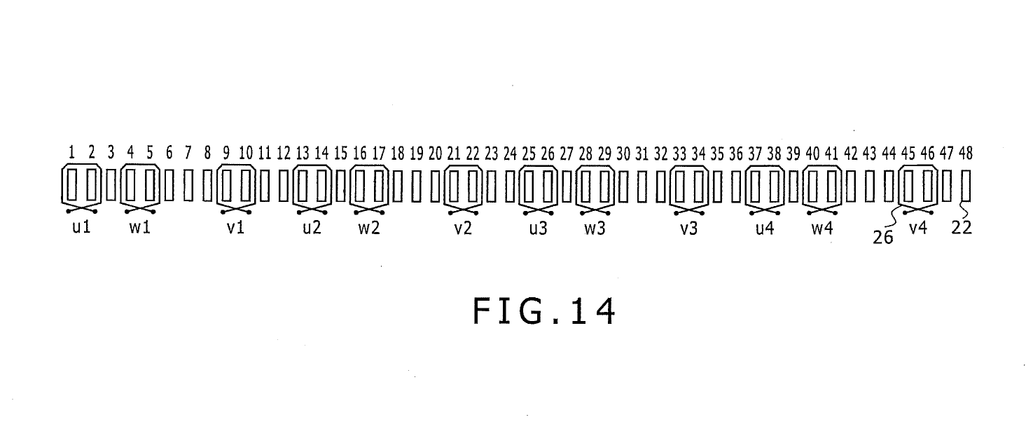

FIG. 14 is a diagram showing a placement of the stator coils 26 in the stator 14 having 48 teeth 22. Although not shown, 32 permanent magnets 18 are placed on the rotor with even spacing such that the N poles and the S poles are alternatingly arranged in the circumferential direction. In other words, the permanent magnets 18 are placed on the rotor 18 such that the spacing of N and S poles of the permanent magnets 18 adjacent in the circumferential direction is 1.5 times the spacing of the teeth 14 adjacent in the circumferential direction.

In FIG. 14, addresses of 1-48 are assigned to the teeth 22 in the order from the left end to the right end. In addition, addresses of U1-U4, V1-V4, and W1-W4 are assigned to the stator coils 26 wound around the teeth 22.

More specifically, in the U-phase stator coils 26, a coil U1 is wound around the first and second teeth 22, a coil U2 is wound around the 13th and 14th teeth 22, a coil U3 is wound around the 25th and 26th teeth 22, and a coil U4 is wound around the 37th and 38th teeth 22. In the V-phase stator coils 26, a coil V1 is wound around the 9th and 10th teeth 22, a coil V2 is wound around the 21st and 22nd teeth 22, a coil V3 is wound around the 33rd and 34th teeth 22, and a coil V4 is wound around the 45th and 46th teeth 22. In the W-phase stator coils 26, a coil W1 is wound around the 4th and 5th teeth 22, a coil W2 is wound around the 16th and 17th teeth 22, a coil W3 is wound around the 28th and 29th teeth 22, and a coil W4 is wound around the 40th and 41st teeth 22.

In the power generator of the related art, the stator coils are placed such that the phase differences between the stator coils of the phases are 120° and even. In the present embodiment, on the other hand, because the stator coils 26 are placed in the manner described above, the phase differences between the phases become different from 120° and not even. With such a configuration, an uneven-phase placement of the stator coils 26 can be realized.

Around the teeth 22 other than the teeth 22 of the addresses described above, no stator coil 26 is wound. That is, no stator coil 26 is wound around the teeth 22 of the addresses of 3, 6-8, 11, 12, 15, 18-20, 23, 24, 27, 30-32, 35, 36, 39, 42-44, 47, and 48. That is, empty teeth 22 exist. By providing the empty teeth 22, or by setting the number of stator coils 26 to be smaller than the number of teeth 22, an optimum layout for achieving the uneven-phase placement of the stator coil 26 can be facilitated.

In the present embodiment, an example configuration has been described in which the number of stator coils 26 is 12, but the present invention is not limited to the number of the stator coils 26 of 12. The number of stator coils 26 may be any number less than the number of all teeth 22 which is 48. In any configuration, the uneven-phase placement of the stator coils 26 can be achieved by connecting the stator coils 26 provided on the teeth 22 and the output side such that the phase differences between phases become uneven, or by not connecting some of the stator coils 26 and the output side.

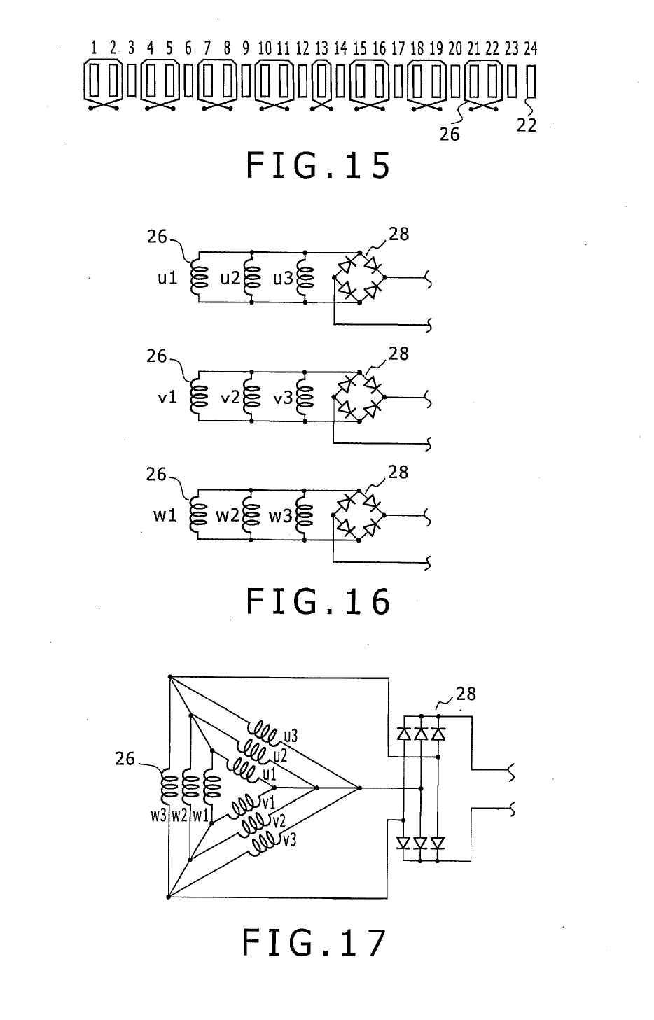

Next, a placement of the stator coils 26 in the stator 14 having 24 teeth 22 will be described with reference to FIG. 15. Although not shown, 16 permanent magnets 18 of the rotor are placed with even spacing such that the N poles and S poles are alternatingly arranged in the circumferential direction. In other words, the permanent magnets 18 are placed on the rotor such that the spacing between the N and S poles of the permanent magnets 18 adjacent in the circumferential direction is 1.5 times the spacing of the teeth 14 adjacent in the circumferential direction.

In FIG. 15, addresses of 1-24 are assigned to the teeth 22 in the order from the left end to the right end. The stator coils 26 are wound around the first and second teeth 22, the fourth and fifth teeth 22, the seventh and eighth teeth 22, the 10th and 11th teeth 22, the 13th tooth 22, the 15th and 16th teeth 22, the 18th and 19th teeth 22, and the 21st and 22nd teeth 22. Around the teeth 22 of the addresses other than those described above, no stator coil 26 is wound. In other words, the stator coil 26 is not wound around the teeth 22 of the addresses of 3, 6, 9, 12, 14, 17, 20, 23, and 24, and the empty teeth 22 exist. In this manner, by providing the empty teeth 22, as described above, an optimum layout for achieving the uneven-phase placement of the stator coils 26 can be facilitated.

Similar to the embodiments which have already been described, the phases of the stator coils 26 in the present embodiment can be arbitrarily set. In other words, the output electric power can be retrieved by an independent (single-phase) output method in which an output circuit is connected to each stator coil 26. Alternatively, the stator coils 26 may be placed such that the U, V, and W-phases are arranged in a disordered manner in the circumferential direction, and the output electric power may be retrieved by the 3-phase AC output method in which the output circuit is connected to each phase. Because an output terminal is provided for each stator coil 26 and the phases of the stator coils 26 can be arbitrarily set by merely changing the connecting method of the output terminals, the degree of freedom of design of the stator 40 can be improved and the adjustment of the output electric power can be facilitated.

FIGS. 16 and 17 show an example of an output circuit in a form different from that of FIG. 3. As shown in FIG. 16, the stator coils 26 of each phase are connected in parallel to each other, and the output terminals thereof are connected to the corresponding rectifier circuits 28, respectively. For example, output terminals of the coils U1, U2, and U3, which are connected in parallel, and the rectifier circuit 28 are connected, the output terminals of the coils V1, V2, and V3, which are connected in parallel, and the rectifier circuit 28 are connected, and the output terminals of the coils W1, W2, and W3, which are connected in parallel, and the rectifier circuit 28 are connected. With such output circuits, the output current of each phase can be increased compared to the output circuit of the related art in which the rectifier circuits are connected respectively to three terminals of the Y connection or the Δ connection. In addition, in this output circuit, because the magnetic resistance with respect to the rotor 12 during power generation is reduced, the rotational speed of the rotor 12 is increased, and as a result, a higher voltage can be achieved for each stator coil 26. FIG. 17 shows a delta connection in which the stator coils 26 of each phase are connected in parallel to each other, and the output terminals thereof are connected respectively to the corresponding rectifier circuits 28. In such a configuration also, the output current of each phase can be increased. The number of the stator coils 26 of each phase is merely exemplary, and the number of the stator coils 26 in this configuration is not limited to 3, and any plural number may be sufficient. When a plurality of stator coils 26 exist for each phase, a configuration may be employed in which the output terminals are connected to separate output circuits, and desired electric power, that is, DC electric power and AC electric power, are simultaneously retrieved. In such a case, the power generator may be equipped and used in a device which simultaneously requires the 3-phase AC electric power and DC electric power such as, for example, an electric vehicle.

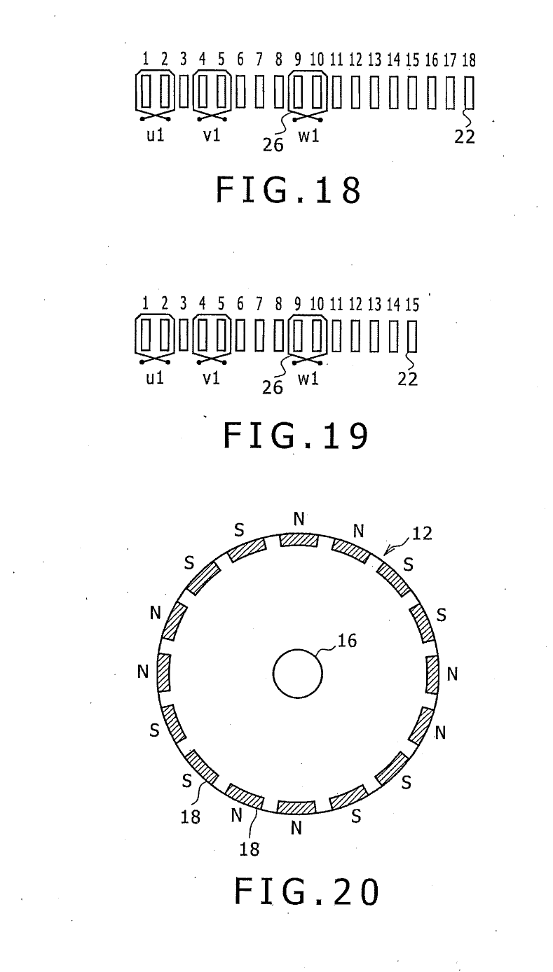

Next, a placement of stator coils 26 in a stator 14 having 18 teeth 22 will be described with reference to FIG. 18. Although not shown, 12 permanent magnets are placed on the rotor with even spacing such that the N and S poles are arranged in an alternating manner in the circumferential direction. In other words, the permanent magnets 18 are placed on the rotor such that the spacing of the N and S poles of the permanent magnets 18 adjacent in the circumferential direction is 1.5 times the spacing of the teeth 14 adjacent in the circumferential direction.

In FIG. 18, addresses of 1-18 are assigned to the teeth 22 in the order from the left end to the right end. In addition, addresses of U1, V1, and W1 are assigned to the stator coils 26 wound around the teeth 22.

More specifically, in the U-phase stator coil 26, a coil U1 is wound around the first and second teeth 22. In the V-phase stator coil 26, a coil V1 is wound around the fourth and fifth teeth 22. In the W-phase stator coil 26, a coil W1 is wound around the 9th and 10th teeth 22.

In this embodiment, with the above-described placement of the stator coils 26, the phase differences between the phases become different from 120° and not even. With such a configuration, the uneven-phase placement of the stator coils 26 can be realized.

Around the teeth 22 of the addresses other than the above-described addresses, no stator coil 26 is wound. That is, no stator coil 26 is wound around the teeth 22 of the addresses of 3, 6-8, and 11-18, and empty teeth 22 exist. In this manner, by providing the empty teeth 22, an optimum layout for achieving the uneven-phase placement of the stator coils 26 is facilitated.

In the present embodiment, an example configuration has been described in which the number of the stator coils 26 is 3, but the present invention is not limited to the number of the stator coils 26 being 3. The number of stator coils 26 may be any number smaller than the total number of teeth 22, which is 18. In any structure, the uneven-phase placement of the stator coils 26 can be realized by connecting the stator coils 26 provided on the teeth 22 and the output side such that the phase differences between the phases are uneven, or by not connecting a part of the stator coils 26 and the output side.

Finally, a placement of the stator coil 26 in the stator 14 having 15 teeth 22 will be described with reference to FIG. 19. Although not shown, 10 permanent magnets 18 are placed on the rotor with even spacing such that the N and S poles are arranged in an alternating manner in the circumferential direction. In other words, the permanent magnets 18 are placed on the rotor such that the spacing of the N and S poles of the permanent magnets 18 adjacent in the circumferential direction is 1.5 times the spacing of the teeth 14 adjacent in the circumferential direction.

In FIG. 19, addresses of 1-15 are assigned on the teeth 22 in the order from the left end to the right end. In addition, addresses of U1, V1, and W1 are assigned to the stator coils 26 wound around the teeth 22.

More specifically, in the U-phase stator coil 26, a coil U1 is wound around the first and second teeth 22. In the V-phase stator coil 26, a coil V1 is wound around the fourth and fifth teeth 22. In the W-phase stator coil 26, a coil W1 is wound around the 9th and 10th teeth 22.

In this embodiment, with the above-described placement of the stator coils 26, the phase differences between the phases become different from 120° and not even. With such a configuration, the uneven-phase placement of the stator coils 26 can be realized.

Around the teeth 22 of the addresses other than the above-described addresses, no stator coil 26 is wound. In other words, no stator coil 26 is wound around the teeth 22 of the addresses 3, 6-8, and 11-15, and empty teeth 22 exist. In this manner, by providing the empty teeth 22, an optimum layout for realizing the uneven-phase placement of the stator coils 26 can be facilitated.

In the present embodiment, an example configuration has been described in which the number of the stator coils 26 is 3, but the present invention is not limited to the number of the stator coils 26 being 3. The number of stator coils 26 may be any number smaller than the total number of teeth 22, which is 18. In any structure, the uneven-phase placement of the stator coils 26 can be realized by connecting the stator coils 26 provided on the teeth 22 and the output side such that the phase differences between the phases are uneven, or by not connecting a part of the stator coils 26 and the output side.

In the embodiments shown in FIGS. 14, 15, 18, and 19, an example configuration where the stator coil 26 is wound around two adjacent teeth 22 has been primarily described, but the present invention is not limited to such a configuration. So long as the uneven-phase placement can be realized, the stator coil 26 may be wound around a plurality of adjacent teeth 22 in a number greater than or equal to two such as, for example, around three, four, or six teeth 22. In addition, in the embodiments shown in FIGS. 14, 15, 18, and 19, example configurations where the numbers of the teeth 22 are 48, 24, 18, and 15 have been described, but the present invention is not limited to these numbers of the teeth 22, and the number of the teeth 22 may be larger than 48, smaller than 15, or a number between 15 and 48.

In addition, in the embodiments shown in FIGS. 14, 15, 18, and 19, example configurations have been described in which the permanent magnets 18 of the rotor are placed with even spacing such that the N and S poles are arranged in an alternating manner in the circumferential direction, but the present invention is not limited to such a configuration. For example, a plurality of N poles, for example, two N poles, may be consecutively arranged and then a plurality of S poles, for example, two S poles, may be consecutively arranged.

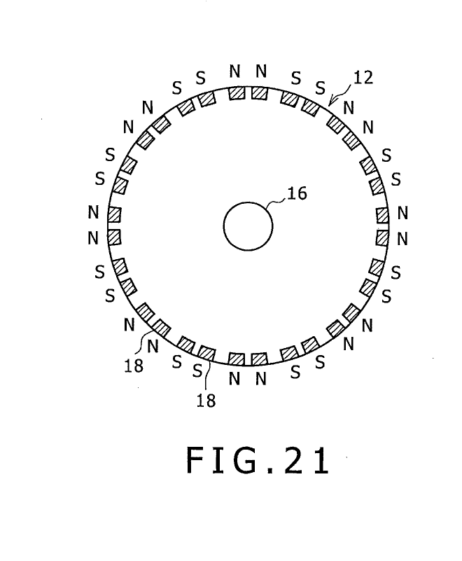

FIG. 20 shows a structure of a rotor corresponding to the stator of FIG. 1 in an alternative configuration. In the rotor 12 of this configuration, the permanent magnets 18 are arranged in the order of N, N, S, S, N, N, S, S, . . . . With such a configuration, an output of approximately twice that of the power generator which uses the rotor 12 shown in FIG. 2 can be obtained. FIG. 21 shows a structure of a rotor corresponding to the stator of FIG. 1 in an alternative configuration. In the rotor 12 of this configuration, the permanent magnets 18 are arranged in the order of N, N, S, S, N, N, S, S, . . . , and the number of the permanent magnets 18 is doubled, that is, the number of permanent magnets 18 is increased from 16 to 32. With such a configuration, the rotational speed of the rotor 12 is reduced compared to the power generator which uses the rotor 12 shown in FIG. 2, and an output of approximately twice that of the power generator which uses the rotor 12 shown in FIG. 2 can be obtained. These arrangements of the permanent magnets 18, that is, the arrangement of the permanent magnets 18 such that the same poles abut can be applied to the rotor 34 shown in FIG. 9 or to the rotor which is used in the power generators shown in FIGS. 14, 15, 18, and 19.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### Explanation of Reference Numerals

10, 30, 32, 38 HIGH-EFFICIENCY POWER GENERATOR; 12, 34 ROTOR; 14, 36, 40 STATOR; 16 INPUT SHAFT; 18 PERMANENT MAGNET; 20 YOKE; 22 TOOTH; 24 SLOT; 26 STATOR COIL; 28 RECTIFIER

1. A high-efficiency power generator, comprising:
a rotor fixed on an input shaft and has comprising a plurality of magnets in a rotor circumferential direction; and
a stator which opposes the rotor in an opposing direction with a predetermined spacing therebetween and comprising stator coils wound around teeth which protrude in the opposing direction,
wherein the stator coils are arranged in an uneven-phase placement.

2. The high-efficiency power generator according to claim 1,
wherein the teeth are placed with even spacing in a stator circumferential direction, and
wherein the stator coils wound around the teeth are connected with respect to an output side such that phase differences between phases are uneven.

3. The high-efficiency power generator according to claim 2,
wherein the teeth are placed with even spacing in the stator circumferential direction,
wherein a number of the stator coils wound around the teeth is smaller than a number of the teeth, and
wherein the stator coils are connected with respect to the output side such that the phase differences between the phases are uneven.

4. A high-efficiency power generator, comprising:
a rotor fixed on an input shaft and comprising a plurality of magnets in a rotor circumferential direction; and
a stator which opposes the rotor in an opposing direction with a predetermined spacing therebetween and which has stator coils wound around a plurality of teeth which protrude in the opposing direction,
wherein the stator coils are arranged in an uneven-load placement.

5. The high-efficiency power generator according to claim 4, wherein
the stator coils are placed in an unevenly distributed manner in a stator circumferential direction.

6. The high-efficiency power generator according to claim 4,
wherein a wire diameter of a stator coil wound around a first tooth of the teeth differs from wire diameters of the stator coils wound around the others of the teeth.

7. The high-efficiency power generator according to claim 4,
wherein a number of windings of a stator coil wound around a first tooth of the teeth differs from numbers of windings of the stator coils wound around the others of the teeth.

8. The high-efficiency power generator according to claim 4,
wherein a magnetic force of a first magnet of the plurality of magnets differs from magnetic forces of the others of the plurality of magnets.

9. A high-efficiency power generator, comprising:
a rotor fixed on an input shaft and comprising a plurality of magnets in a rotor circumferential direction; and
a stator which opposes the rotor in an opposing direction with a predetermined spacing therebetween and comprising teeth which protrude in the opposing direction,
wherein the teeth are placed with even spacing in a stator circumferential direction, and
wherein stator coils wound around the teeth are placed such that a number of the stator coils is smaller than a number of the teeth, and the stator coils are arranged in an uneven-phase placement.

10. The high-efficiency power generator according to claim 9,
wherein each of the stator coils is wound around a plurality of adjacent teeth.

11. The high-efficiency power generator according to claim 9,
wherein the stator coils are connected with respect to an output side such that phase differences between phases are uneven.
